(19) United States
(12) Patent Application Publication
(10) Pub. No.: US 2023/0095347 A1
(43) Pub. Date: Mar. 30, 2023

(54) SEEDBED FLOOR CONDITIONER

(71) Applicant: CNH Industrial America LLC, New Holland, PA (US)

(72) Inventor: Michael George Kovach, Morton, IL (US)

(73) Assignee: CNH INDUSTRIAL AMERICA LLC, (omitted)

(21) Appl. No.: 17/478,210

(22) Filed: Sep. 17, 2021

(51) Int. Cl. A01B 49/02; A01B 35/16; A01B 5/04

(52) U.S. Cl. CPC A01B 49/027; A01B 5/04; A01B 35/16

(57) ABSTRACT

A tilling implement includes a frame having a front and a rear. The tilling implement also includes a first row of disc blades coupled to the frame adjacent the front. The tilling implement further includes a rolling seedbed floor conditioner coupled to the frame adjacent the rear and behind the first row of disc blades, wherein the rolling seedbed floor conditioner includes a plurality of blades, the plurality of blades are indexed to the first row of disc blades, and the rolling seedbed floor conditioner is configured to till the soil between disc blades of the first row of disc blades to smooth a seedbed floor below a soil surface.

### BACKGROUND

The disclosure relates generally to tillage implements and, in particular, to tillage implements utilizing seedbed floor conditioners.

A wide range of agricultural implements have been developed and are presently in use for tilling, cultivating, harvesting and so forth. Tillage implements, for example, are commonly towed behind tractors and may cover wide swaths of ground which may include various types of residue. Such residue may include materials left in the field after the crop has been harvested. These residues typically include stalks and stubble, leaves and seed pods. Good management of field residues can increase efficiency of irrigation and control of erosion in the field.

Certain agricultural implements include ground engaging tools configured to interact with the soil. For example, a tillage implement may include gangs of disc blades configured to break up the soil for subsequent planting or seeding operations. The configuration of the tilling implement gangs and their constituent discs will determine the quality and quantity of the passes required to effectively till an area of soil. For example, typical tillage implements may utilize two rows of blades or discs running at a certain defined angle relative to a direction of travel. This results in untilled soil between the blades which is not ideal for seed placement and germination. Certain tillage implements may utilize adjustable blades angles (e.g., adjustable between approximately 0 and 19 degrees relative to the direction of travel) which create even wider sections between the blades of untilled soil. In this scenario, during planting, some of the seed are disposed on the tilled areas of soil while other seeds are disposed on untilled areas of soil. This results in variable seed germination and affects root growth and yield.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In one embodiment, a tilling implement is provided. The tilling implement includes a frame having a front and a rear. The tilling implement also includes a first row of disc blades coupled to the frame adj acent the front. The tilling implement further includes a rolling seedbed floor conditioner coupled to the frame adjacent the rear and behind the first row of disc blades, wherein the rolling seedbed floor conditioner includes a plurality of blades, the plurality of blades are indexed to the first row of disc blades, and the rolling seedbed floor conditioner is configured to till the soil between disc blades of the first row of disc blades to smooth a seedbed floor below a soil surface.

In another embodiment, a rolling seedbed floor conditioner for a tilling implement is provided. The rolling seedbed floor conditioner includes a row bar, a mounting bracket coupled to the row bar, and a shaft coupled to the mounting bracket. The rolling seedbed floor conditioner also includes a plurality of blades disposed on the shaft, wherein each blade of the plurality of blades of the rolling seedbed floor conditioner includes a hub and a plurality of tangs circumferentially disposed about the hub relative to a rotational axis of the hub.

In a further embodiment, a tilling implement is provided. The tilling implement includes a frame having a front and a rear. The tilling implement also includes a first row of disc blades coupled to the frame adjacent the front. The tilling implement further includes a rolling seedbed floor conditioner coupled to the frame adjacent the rear and behind the first row of disc blades, wherein a first angle of the plurality of blades of the rolling seedbed floor conditioner relative to a direction of travel of the tilling implement is configured to change as a second angle of the disc blades of the first row of disc blades changes relative to the direction of travel.

### DRAWINGS

These and other features, aspects, and advantages of the present disclosure will become better understood when the following detailed description is read with reference to the accompanying drawings in which like characters represent like parts throughout the drawings, wherein:

FIG. 1 is a partial perspective view of an embodiment of an implement having a rolling seedbed floor conditioner, in accordance with aspects of the present disclosure;

FIG. 2 is a partial top view of the implement in FIG. 1 (e.g., having the rolling seedbed floor conditioner and pairs of blades on blade rows at approximately 16 and 0 degrees, respectively);

FIG. 3 is a partial top view of the implement in FIG. 1 (e.g., having the rolling seedbed floor conditioner and pairs of blades on blade rows at approximately 10 and 8 degrees, respectively);

FIG. 4 is a partial top view of the implement in FIG. 1 (e.g., having the rolling seedbed floor conditioner and pairs of blades on blade rows at approximately 0 and 16 degrees, respectively);

FIG. 5 is a partial front view of the implement in FIG. 1 (e.g., having the rolling seedbed floor conditioner and pairs of blades on blade rows at approximately 16 and 0 degrees, respectively);

FIG. 6 is a partial front view of the implement in FIG. 1 (e.g., having the rolling seedbed floor conditioner and pairs of blades on blade rows at approximately 10 and 8 degrees, respectively);

FIG. 7 is a partial front view of the implement in FIG. 1 (e.g., having the rolling seedbed floor conditioner and pairs of blades on blade rows at approximately 0 and 16 degrees, respectively);

FIG. 8 is a partial front view of the implement in FIG. 1 (e.g., illustrating a soil depth for the blades of the rolling seedbed floor conditioner and the pairs of blades on blade rows); and

FIG. 9 is a schematic diagram illustrating the relative diameters of the blades of a rolling seedbed floor conditioner, in accordance with aspects of the disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is generally directed to a seedbed floor conditioner (e.g., rolling seedbed floor conditioner) for an implement (e.g., tillage or ground working implement). An implement includes a frame and a first row of blades (e.g., fluted concave disc blades) coupled to the frame adjacent a front of the frame. In certain embodiments, the seedbed floor conditioner also includes a second row of blades located behind the first row of blades. The implement also includes a rolling seedbed floor conditioner coupled to the frame adjacent the rear and located behind the first row (and second row) of blades. The seedbed floor condition includes a plurality of blades (e.g., fan-like or propeller-like blades) that are indexed to the first row (and second row) of blades. The seedbed floor conditioner is configured to till the soil between the disc blades of the first row (and second row) of blades to smooth a seedbed floor below a soil surface. The blades of the rolling seedbed floor conditioner will remove untilled areas left by the row of blades. In certain embodiments, as the angle of the disc blades on the rows of disc blades change, the angle of the seedbed floor conditioner changes. For example, as the angle of the disc blades decreases, the angle of the seedbed floor conditioner increases to cover additional untilled areas and vice versa. In certain embodiments, a bottom of the blades of the seedbed floor conditioner operate at a same soil depth as the row of disc blades. In contrast to typical soil conditioners, the rolling seedbed floor conditioner enables tillage of the soil without creating a smear layer (e.g., due to no backside pressure on the blades). The disclosed seedbed floor conditioner enables even seed germination, strong root growth, and increased crop yield.

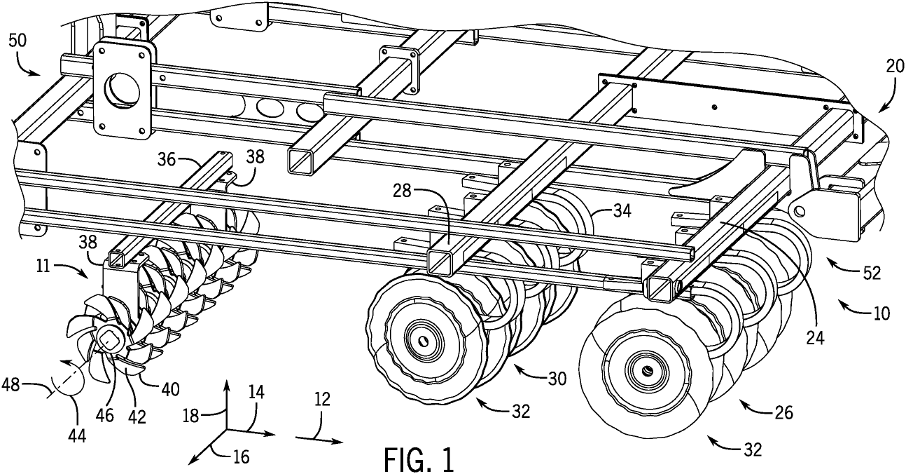

Referring now to the drawings, FIG. 1 is a partial perspective view of an agricultural implement 10 (e.g., tillage implement or ground working implement) having a rolling seedbed floor conditioner 11. Certain elements of the implement are not shown (e.g., transport wheels, etc.). The implement 10 may be towed by a tractor in a direction of travel 12. The implement 10 and its components may be described with reference to an axial axis or direction 14, a lateral axis or direction 16, and a vertical axis or direction 18.

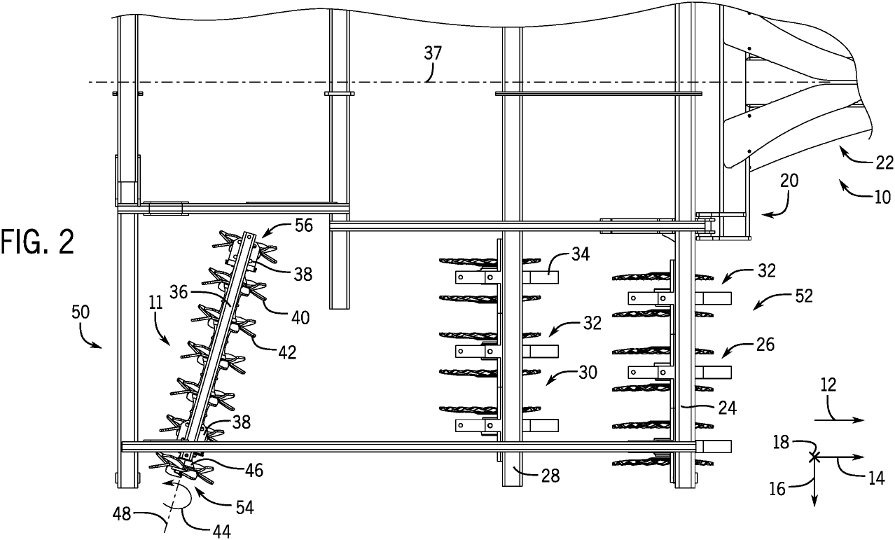

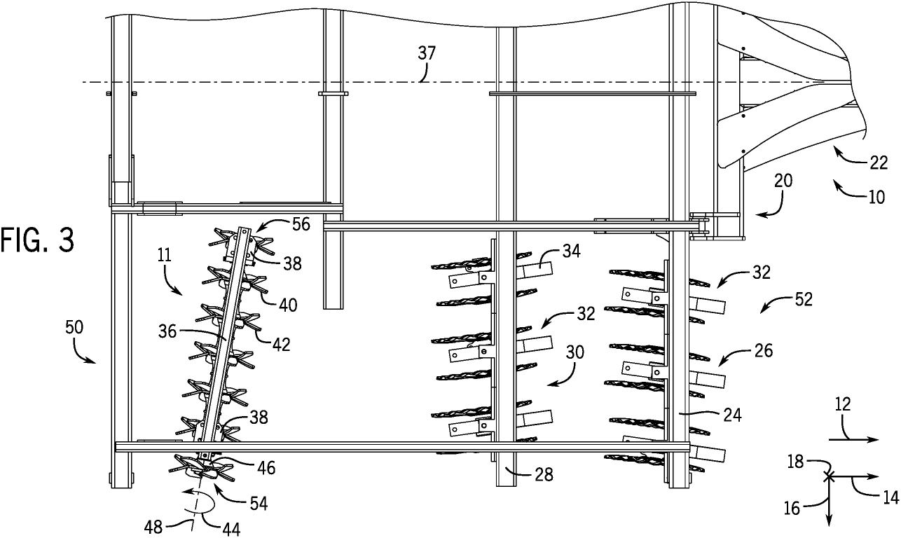

The implement 10 includes a frame 20 (e.g., main frame) that includes a hitch assembly (e.g., hitch assembly 22 as depicted in FIGS. 2-5) for coupling the implement 10 to the tractor. The frame 20 includes a first frame element 24 (e.g., row bar or tool bar) that supports a first disc row 26 and a second frame element 28 (e.g., row or tool bar) that supports a second disc row 30. The disc rows 26, 30 may be referred to as gangs of disc blades. As depicted, the first disc row 26 is located in front of the second disc row 30. Each disc row 26, 30 includes pairs of disc blades 32 each coupled to a mounting bracket 34 that is coupled the respective frame elements 24, 28. In certain embodiments, the disc blades 38, 40 may be mounted with a camber to minimize blade to soil backpressure. In certain embodiments, the angle of attack (e.g., angle of blades relative to the direction of travel 12) of the pairs of disc blades 32 is configured to be adjusted by an operator (e.g., via linkages coupled to a cylinder).

The number of pairs of disc blades 32 on a respective frame element may vary (e.g., 2, 3, 4, 5 or more). As depicted, the frame elements 24, 28 each include 3 pairs of disc blades 32. As depicted, disc rows 26, 30 of pairs of disc blades 32 are only illustrated on the portion of the implement 10 to the right of a center line (e.g., center line 37 in FIGS. 2-5). Similarly, the portion of the implement 10 to the left of the center line may include disc rows of pairs of disc blades 32. The number of disc rows on each side of the implement 10 may vary (e.g., 1, 2, 3, or more). As depicted, each side of the implement 10 includes two disc rows (e.g., disc rows 26, 30).

The implement 10 also includes a seedbed floor conditioner 11 (e.g., rolling seedbed floor conditioner). The seedbed floor conditioner 11 includes a frame element 36 (e.g., row or tool bar). The seedbed floor conditioner 11 also includes a pair of mounting brackets 38 coupled to the frame element 36 and a shaft (not shown). A plurality of blades 40 (e.g., fan-like or propeller-like blades) are coupled to shaft. Each blade 40 includes a plurality of props or tangs 42 coupled to and circumferentially 44 disposed about a hub 46 relative to a rotational axis 48 of the hub 46 or blades 40. The number of props or tangs 42 may vary. As depicted, each blade 40 includes 8 props or tangs 42. The props or tangs 42 are mounted or formed on the hub 46 at a compound angle with respect to the direction of travel 12. The compound angle includes a steering angle and tilt angle relative to the direction of travel 12. The compound angle enables the blades 40 to lack backside pressure with the soil. The blades 40 of the seedbed floor conditioner 11 operate at a same soil depth (e.g., tillage depth) as the pairs of disc blades 32 on both disc rows 26, 30.

The seedbed floor conditioner 11 is located behind both disc rows 26, 30. In particular, the seedbed floor conditioner 11 is located closer to or more adjacent a rear portion 50 of the frame 20 and the disc row 26 is located closer to or more adjacent a front portion 52 of the frame 20. The disc row 30 is located between the disc row 26 and the seedbed floor conditioner 11.

The pairs of disc blades 32 in the first and second disc rows 26, 30 are indexed with respect to each other so that pairs of disc blades 32 in the second disc row 30 operate in the spaces between where the pairs of disc blades 32 in the first disc row 26 operate. The blades 40 of the seedbed floor conditioner 11 are indexed with respect to pairs of disc blades 32 in both the first and second disc rows 26, 30 so that the blades 40 operate in the spaces between where the pairs of disc blades 32 of both the disc rows 26, 30 operate.

As described in greater below, the angle of the seedbed floor conditioner 11 (and the blades 40) relative to the direction of travel 12 is configured to be adjusted by an operator (e.g., via linkages coupled to a cylinder). The angle of the seedbed floor conditioner 11 (and the blades 40) relative to the direction of travel 12 changes as the angle of attack (e.g., angle of pairs of disc blades 32 relative to the direction of travel 12) of the pairs of disc blades 32 changes. For example, as the angle of the pairs of disc blades 32 decreases, the angle of the seedbed floor conditioner 11 increases to cover additional untilled areas. Conversely, as the angle of the pairs of disc blades 32 increases, the angle of the seedbed floor conditioner 11 decreases. The angle of attack for the pairs of disc blades 32 may range from approximately 0 to 16 degrees. In certain embodiments, the upper limit of the angle of attack for the pairs of blades 32 may be a little higher (e.g., 17, 18, or 19 degrees or more). The angle of the seedbed floor conditioner 11 (and the blades 40) may range from approximately 0 to 16 degrees. In certain embodiments, the upper limit of the angle of the seedbed floor conditioner 11 may be a little higher (e.g., 17, 18, or 19 degrees or more).

The number of blades 40 on the seedbed floor conditioner 11 may vary (e.g., 2, 3, 4, 5, 6, 7, 8, 9, or more). As depicted, the seedbed floor conditioner 11 includes 7 blades 40. The seedbed floor conditioner 11 includes at least one more blade 40 than the number of disc blades on each respective disc row 26, 30. In certain embodiments, the seedbed floor conditioner 11 includes more than one blade 40 than the number of disc blades on each respective disc row 26, 30.

In certain embodiments, a diameter of each blade 40 may be the same on the seedbed floor conditioner 11. In certain embodiments, at least one of the blades 40 may have a different diameter (e.g., smaller diameter) from the rest of the blades 40. In certain embodiments, at most, two of the blades 40 may have a different diameter (e.g., smaller diameter) from the rest of the blades 40. If one or more blades 40 have a smaller diameter, the smaller blades 40 will be located on an end of the seedbed floor conditioner 11.

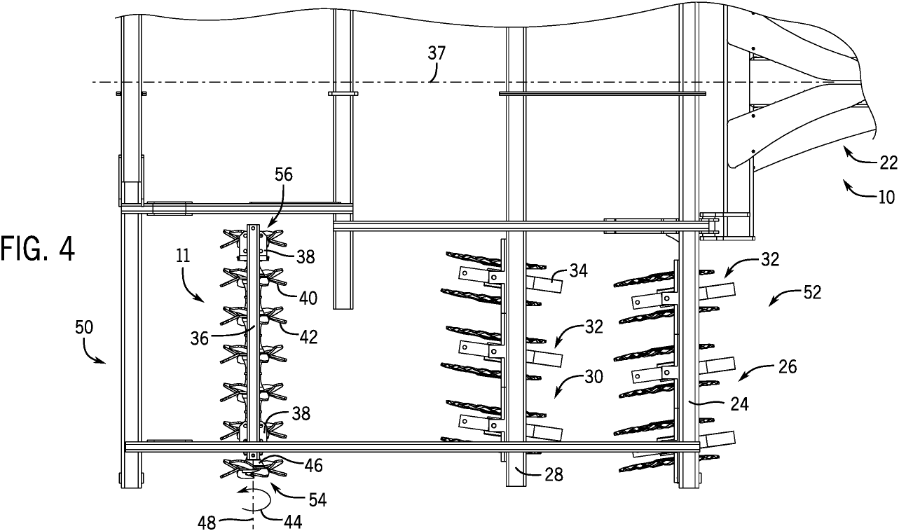

FIGS. 2-4 are partial top views of the implement in FIG. 1 depicting the rolling seedbed floor conditioner 11 and the pairs of blades 32 at different angles relative to the direction of travel 12. The angle of the rolling seed bed floor conditioner 11 relative to the direction of travel 12 is approximately 16, 10, and 0 degrees in FIGS. 2-4, respectively. The angle of each pair of disc blades 32 on the disc rows 26, 30 is approximately 0, 8, and 16 degrees in FIGS. 2-4, respectively. As noted above, the angle of the seedbed floor conditioner 11 (and the blades 40) relative to the direction of travel 12 changes as the angle of attack (e.g., angle of pairs of disc blades 32 relative to the direction of travel 12) of the pairs of disc blades 32 changes. For example, as the angle of the pairs of disc blades 32 decreases, the angle of the seedbed floor conditioner 11 increases to cover additional untilled areas as depicted when transitioning from the angles in FIG. 4 to the angles in FIG. 2. Conversely, as the angle of the pairs of disc blades 32 increases, the angle of the seedbed floor conditioner 11 decreases as depicted when transitioning from the angles in FIG. 2 to the angles in FIG. 4. The more aggressive the angle of attack for the pair of disc blades 32, the more soil is left untilled between blades and the rougher the seedbed floor becomes. Thus, the angle of the seedbed floor conditioner may be changed to counter this and smooth the seedbed floor. The angle of attack for the pairs of disc blades 32 may range from approximately 0 to 16 degrees. In certain embodiments, the upper limit of the angle of attack for the pairs of blades 32 may be a little higher (e.g., 17, 18, or 19 degrees or more). The angle of the seedbed floor conditioner 11 (and the blades 40) may range from approximately 0 to 16 degrees. In certain embodiments, the upper limit of the angle of the seedbed floor conditioner 11 may be a little higher (e.g., 17, 18, or 19 degrees or more).

As depicted in FIGS. 2-4, each blade 40 of the seedbed conditioner 11 includes a plurality of props or tangs 42 coupled to and circumferentially 44 disposed about the hub 46 relative to the rotational axis 48 of the hub 46 or blades 40. The number of props or tangs 42 may vary. As depicted, each blade 40 includes 8 props or tangs 42. The props or tangs 42 are mounted or formed on the hub 46 at a compound angle with respect to the direction of travel 12. The compound angle includes a steering angle and tilt angle relative to the direction of travel 12. As depicted, the prop or tangs 42 alternate between being tilted or angled toward a longitudinal end 54 of the seedbed floor conditioner 11 and an opposite longitudinal end 56 of the seedbed floor conditioner 11. The compound angle enables the blades 40 to lack backside pressure with the soil.

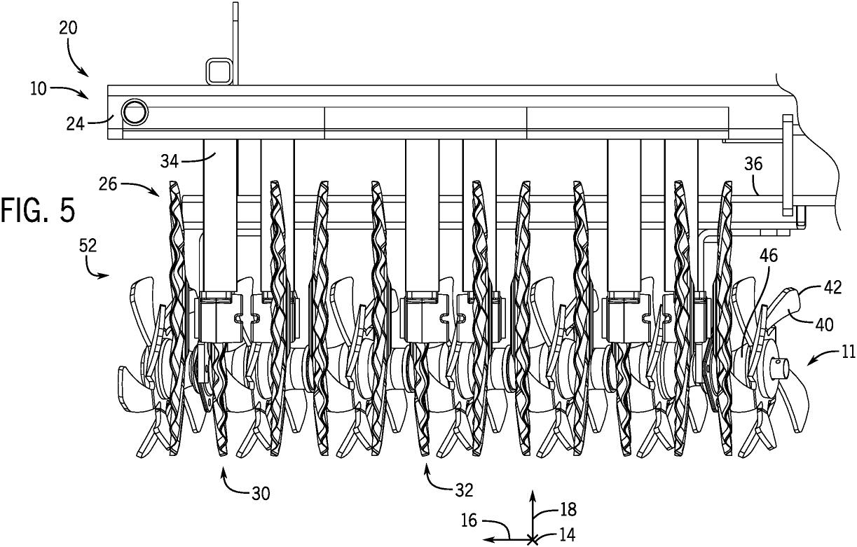

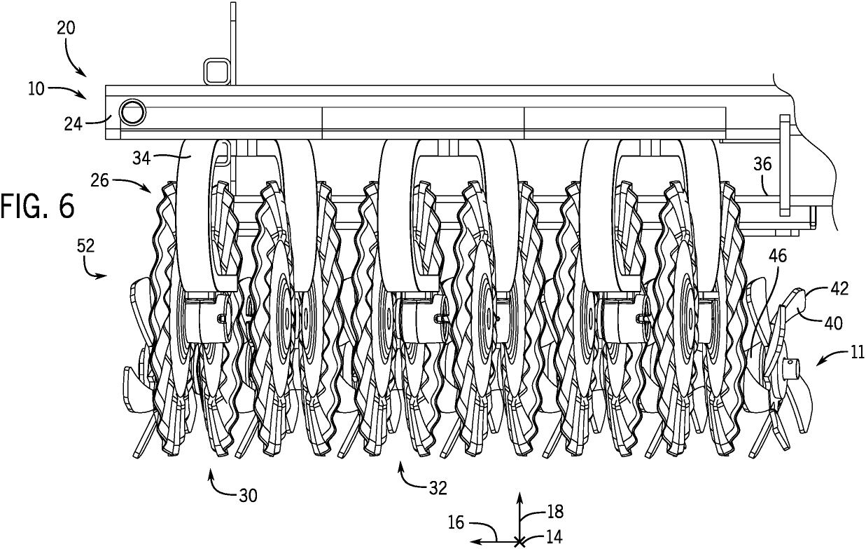

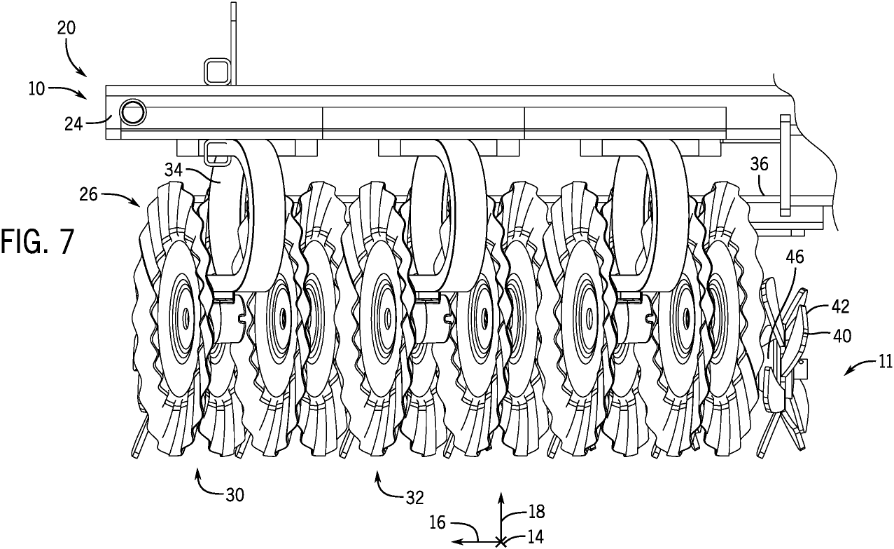

In addition, as depicted in FIGS. 2-4, the pairs of disc blades 32 in the first and second disc rows 26, 30 are indexed with respect to each other so that pairs of disc blades 32 in the second disc row 30 operate in the spaces between where the pairs of disc blades 32 in the first disc row 26 operate. The blades 40 of the seedbed floor conditioner 11 are indexed with respect to pairs of disc blades 32 in both the first and second disc rows 26, 30 so that the blades 40 operate in the spaces between where the pairs of disc blades 32 of both the disc rows 26, 30 operate. The positioning of the blades 40 relative to the pairs of blades 32 in both the disc rows 26, 30 is further depicted in FIGS. 5-7. The angles for the blades 40 and the pair of blades 32 in FIGS. 5-7 correspond to the angles in FIGS. 2-4.

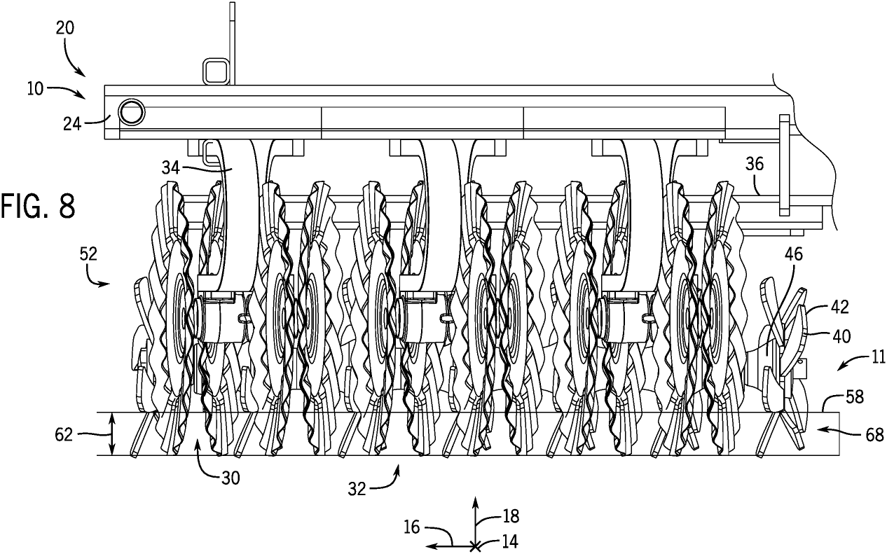

FIG. 8 is a partial front view of the implement in FIG. 1 illustrating a soil depth for the blades 40 of the rolling seedbed floor conditioner 11 and the pairs of blades 32 on the blade rows 26, 30. As depicted, bottom portions of the blades 40 and the pairs of blades 32 are disposed below a top surface 58 of soil 60 at a soil depth 62. As depicted, the bottom portions of the blades 40 on the rolling seedbed floor conditioner 11 operate at the same soil depth 62 as the pairs of disc blades 32 on the blade rows 26, 30.

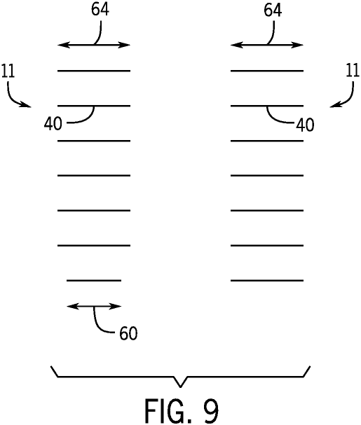

FIG. 9 is a schematic diagram illustrating the relative diameters of the blades 40 of the rolling seedbed floor conditioner 11. The blades 40 of the rolling seedbed floor conditioner 11 are represented by lines. As depicted on the right side of FIG. 9, a diameter 64 of each blade 40 may be the same on the seedbed floor conditioner 11. In certain embodiments, as depicted on the left side of FIG. 9, at least one of the blades 40 may have a different diameter 66 (e.g., smaller diameter) from the diameter 64 of the rest of the blades 40. In certain embodiments, at most, two of the blades 40 may have a different diameter (e.g., smaller diameter) from the rest of the blades 40. If one or more blades 40 have a smaller diameter, the smaller blades 40 will be located on an end of the seedbed floor conditioner 11.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]...” or “step for [perform]ing [a function]... ”, it is intended that such elements are to be interpreted under 35 U.S.C. 112(f). However, for any claims containing elements designated in any other manner, it is intended that such elements are not to be interpreted under 35 U.S.C. 112(f).

1. A tilling implement, comprising:
a frame having a front and a rear;
a first row of disc blades coupled to the frame adjacent the front;
a rolling seedbed floor conditioner coupled to the frame adjacent the rear and behind the first row of disc blades, wherein the rolling seedbed floor conditioner comprises a plurality of blades, the plurality of blades are indexed to the first row of disc blades, and the rolling seedbed floor conditioner is configured to till the soil between disc blades of the first row of disc blades to smooth a seedbed floor below a soil surface.

2. The tilling implement of claim 1, comprising a second row of disc blades coupled to frame between the first row of disc blades and the rolling seedbed floor conditioner, wherein the plurality of blades are indexed to the second row of disc blades.

3. The tilling implement of claim 1, wherein a number of blades on the rolling seedbed floor conditioner is greater than a number of disc blades on the first row disc blades.

4. The tilling implement of claim 1, wherein the plurality of blades on the rolling seedbed floor conditioner are configured to operate at a same soil depth as the first row of disc blades.

5. The tilling implement of claim 1, wherein a first angle of the rolling seedbed floor conditioner relative to a direction of travel of the tilling implement is configured to change as a second angle of the disc blades of the first row of disc blades changes relative to the direction of travel.

6. The tilling implement of claim 5, wherein the first angle of the rolling seedbed floor conditioner relative to the direction of travel is configured to increase as the second angle of the disc blades of the first row of disc blades decreases relative to the direction of travel.

7. The tilling implement of claim 5, wherein the first angle of the rolling seedbed floor conditioner relative to the direction of travel is configured to decrease as the second angle of the disc blades of the first row of disc blades increases relative to the direction of travel.

8. The tilling implement of claim 1, wherein each blade of the plurality of blades of the rolling seedbed floor conditioner comprises a hub and a plurality of tangs circumferentially disposed about the hub relative to a rotational axis of the hub.

9. The tilling implement of claim 8, wherein for each blade the plurality of tangs are disposed at a compound angle on the hub relative to a direction of travel of the tilling implement and configured to not generate backside pressure when moving through soil.

10. The tilling implement of claim 1, wherein a diameter of each blade of the plurality of blades of the rolling seedbed floor conditioner is the same.

11. The tilling implement of claim 1, wherein a diameter of at least one blade of the plurality of blades of the rolling seedbed floor conditioner is different from a rest of the blades of the plurality of blades.

12. A rolling seedbed floor conditioner for a tilling implement, comprising:
a row bar;
a mounting bracket coupled to the row bar;
a shaft coupled to the mounting bracket; and
a plurality of blades disposed on the shaft, wherein each blade of the plurality of blades of the rolling seedbed floor conditioner comprises a hub and a plurality of tangs circumferentially disposed about the hub relative to a rotational axis of the hub.

13. The rolling seedbed floor conditioner of claim 12, wherein for each blade the plurality of tangs are disposed at a compound angle on the hub relative to a direction of travel of the tilling implement and configured to not generate backside pressure when moving through soil.

14. The rolling seedbed floor conditioner of claim 12, wherein a diameter of each blade of the plurality of blades of the rolling seedbed floor conditioner is the same.

15. The rolling seedbed floor conditioner of claim 12, wherein a diameter of at least one blade of the plurality of blades of the rolling seedbed floor conditioner is different from a rest of the blades of the plurality of blades.

16. The rolling seedbed floor conditioner of claim 12, wherein the rolling seedbed floor conditioner is configured to be coupled to a frame of the tillage implement behind at least one row of disc blades, and wherein the plurality of blades of the rolling seedbed floor conditioner are configured to be indexed to the first row of disc blades when coupled to the frame, and the rolling seedbed floor conditioner is configured to till the soil between disc blades of the first row of disc blades to smooth a seedbed floor below a soil surface.

17. The rolling seedbed floor conditioner of claim 16, wherein the plurality of blades on the rolling seedbed floor conditioner are configured to operate at a same soil depth as the first row of disc blades.

18. The rolling seedbed floor conditioner of claim 16, wherein a first angle of the rolling seedbed floor conditioner relative to a direction of travel of the tilling implement is configured to change as a second angle of the disc blades of the first row of disc blades changes relative to the direction of travel.

19. A tilling implement, comprising:
a frame having a front and a rear;
a first row of disc blades coupled to the frame adjacent the front;
a rolling seedbed floor conditioner coupled to the frame adjacent the rear and behind the first row of disc blades, wherein the rolling seedbed floor conditioner comprises a plurality of blades, wherein a first angle of the rolling seedbed floor conditioner relative to a direction of travel of the tilling implement is configured to change as a second angle of the disc blades of the first row of disc blades changes relative to the direction of travel.

20. The tilling implement of claim 19, wherein the plurality of blades on the rolling seedbed floor conditioner are configured to operate at a same soil depth as the first row of disc blades.
